(19) United States
(12) Patent Application Publication
(10) Pub. No.: US 2025/0180007 A1
(43) Pub. Date: Jun. 5, 2025

(54) SYSTEM FOR CONTROLLING A FLUID CIRCULATION PUMP AND IONIZER

(71) Applicants: Mitch Saccoccio, Hays, NC (US); Jonathan Bonelli, New York, NY (US)

(72) Inventors: Mitch Saccoccio, Hays, NC (US); Jonathan Bonelli, New York, NY (US)

(21) Appl. No.: 18/964,832

(22) Filed: Dec. 2, 2024

Related U.S. Application Data
(60) Provisional application No. 63/605,119, filed on Dec. 1, 2023.

(51) Int. Cl. F04B 49/20; E04H 4/12

(52) U.S. Cl. CPC F04B 49/20; E04H 4/1209

(57) ABSTRACT

The invention controls pumps, an ionizer, and other devices associated with fluid circulation. An ionizer is attached to a port on the pump into a flowing fluid system, e.g., a fluid pump or filter, and having a pair of electrodes for electrolytically ionizing fluid flowing through the system, a head in which the two electrodes are mounted, and wires situated within and extending out from the head for connecting each electrode with a controller and a current source. The ionizer head can be easily secured onto a port of the fluid system, such as a pump or filter. Power to the ionizer can be synchronized with power to the motor of the pump in order to provide control over both the motor and ionizer in tandem.

### REFERENCE TO PRIOR APPLICATION

This application claims the benefit of U.S. Provisional Application No. 63/605,119, filed Dec. 1, 2023, the entire contents of which are incorporated herein by reference.

### FIELD OF THE INVENTION

The present invention relates to apparatus and methods for controlling pumps, ionizers, and other devices associated with a fluid circulation system.

### BACKGROUND

Swimming on a hot summer day is one of the best ways to cool down and relax, but it is almost impossible to be sure that the pool is properly maintained and that the water is clean and safe for activity. A number of methods are commonly used to filter and sterilize pool water. The most commonly used methods and devices are chemicals or highly complex filtration systems to remove harmful bacteria and unwanted debris from water. Chlorine, for example, is widely used in swimming pools around the world, including the United States, because it kills bacteria and controls algae. Pool water is generally highly treated, which can lead to health problems for people with chlorine allergies or sensitive skin. Even for people without a heightened sensitivity to chlorine, chlorinated pool water can cause a number of problems, especially because it emits a strong odor and can cause discomfort when in contact with the swimmer's eyes.

Therefore, there is a need for alternative methods and devices to filter and disinfect pool water. Over the past half century, many alternatives have been developed that completely eliminate or significantly reduce the use of chlorine and other chemicals in swimming pools. Ionizers emit ions into pool water using electrically charged electrodes made of metal, typically copper, silver, nickel, and the like. These ions of these metals bind to the contaminants and eliminate them from the pool water. Disinfection devices of this type are generally inexpensive. In addition, the ionizer does not cause many chlorine-related problems such as odor, skin irritation, and equipment corrosion.

One approach has been ionizing the pool water flowing out of, and then back to, the body of water. Typically, a circulating flow of water is pumped out from the body of water, past ionizing electrodes located at a point within the plumbing system at a location proximal to the pump, and then back to the body of water with the unwanted contaminants hopefully destroyed. Such ionizing electrodes are required to be directly mounted within the pool's plumbing, e.g., by drilling into or cutting the pipes, which can be a cumbersome arrangement. This arrangement also requires a flow switch coupled and proximate to the ionizer in order to activate and deactivate the ionizer.

The prior art ionizers also require a separate power source often separate from the power source for a pump. Further, any repair of such ionizing electrodes previously required cutting into the pipes in which the electrodes were mounted to remove them. Furthermore, the flow switch may be prone to failure, resulting in the pool system failing to properly ionize the pool water as well as burdening a user with additional costs for replacement of the flow switch.

Accordingly, it is a problem in the prior art to situate the ionizing mechanism in the circulating fluid to maximize removal of such contaminants, in facilitated manner and avoiding cumbersome arrangements and costly repair technique, further simplifying repair.

Although, in the prior art system there is also the problem where continued use of the ionizer, even when fluid is not flowing through the pool plumbing system, may cause the ionizer to degrade faster, requiring more frequent replacement of this disposable part.

Thus, there is a need to control the power to the ionizer in order for the ionizer to activate only when fluid is circulating through the system and eliminate unnecessary additional steps in order to ionize fluid in a circulation system, reduce additional costs to the user for replacement and service of additional parts, and prolong use of the ionizer within the pool system.

### BRIEF SUMMARY OF THE INVENTION

The present invention solves at least the aforementioned problems and aims to reduce the need for hazardous chemicals or complex filtration devices and systems that require significant maintenance while creating clean and safe swimming conditions for the user.

Various apparatus and methods have been proposed for controlling pumps, ionizers, and other devices associated with fluid circulation and treatment system, such as a swimming pool, spa, decorative water fountain, drilled wells, the supply of water to canals, and so on. More recently, digital controllers have been utilized to perform such functions programmatically and interactively.

The present invention consists of a system for controlling a fluid circulating system that includes a pump, a motor and an ionizer wherein activation of the ionizer is dependent upon activation of the motor.

An ionizer is attached to a port of a fluid circulating system, e.g., a fluid pump or filter, and having a pair of electrodes for electrolytically ionizing fluid flowing through the system, a head in which the two electrodes are mounted, and wires situated within and extending out from the head for connecting each electrode to the controller and a power source. In an embodiment, the pump can be a dual port pump having multiple ports to allow for retrofitting said pump into existing pumping systems in either the vertical or horizontal direction. The ionizer can be attached to either one of said ports, or both, in the dual port pump. A power source can be connected to the dual port pump as well as an ionizer unlike the conventional art which requires an additional power source for the ionizer. The need for a flow switch in the prior art to divert fluid to and from the ionizer is also eliminated. In a fluid circulation system, a fluid outlet through which fluid exits, a fluid inlet for returning fluid, a pump for moving the fluid from the fluid outlet to the fluid inlet, a conduit providing fluid communication between the fluid outlet and the pump and a return conduit providing fluid communication between the pump and the fluid inlet are provided. An embodiment of the corresponding motor used in conjunction with the present disclosure features a variable, dual, or single speed motor couplable to the pump for turning it. A controller is electrically coupled to the motor in order to determine the amount of electrical power delivered to the motor and the rotational speed of the motor. An electrical load sensing circuit senses the electrical load on the motor for turning the pump. The controller turns on or activates the motor simultaneously with the ionizer in the dual port pump.

Some examples of the pumping system capable of housing a motor and ionizer are shown in U.S. Pat. Nos. 9,714,665; 10,323,651; and 10,760,586, as well as pending U.S. Patent Application Publication No. 2024/0375979; the disclosures of each of which are incorporated herein by reference.

### BRIEF DESCRIPTION OF THE DRAWINGS

Various embodiments are described below with reference to the drawings wherein:

FIG. 1 is an elevational view of a fluid circulation system having a motor, a pump and an ionizer coupled to a port of the pump, and illustrating a controller mounted on the circulation pump and coupled to the ionizer according to an embodiment of the present invention.

FIG. 2 is an elevational view similar to FIG. 1 illustrating the ionizer coupled to another port of the circulation pump according to an embodiment of the present invention.

FIG. 3 is a flow chart illustrating operation of a fluid circulation system having a motor capable of dual speed operation according to an embodiment of the present invention.

FIG. 4 is a flow chart illustration operation of a fluid circulation system having a motor capable of variable speed operation according to an embodiment of the present invention.

FIG. 5 is block-diagrams illustrating each component of the fluid circulation system according to an embodiment of the present invention.

FIG. 6 is a front plan-view of a user interface for controlling the controller according to an embodiment of the present invention.

FIG. 7 is a partially exploded view of the ionizer according to an embodiment of the present invention.

Like reference numerals indicate similar parts throughout the figures.

### DESCRIPTION OF THE PREFERRED EMBODIMENTS

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

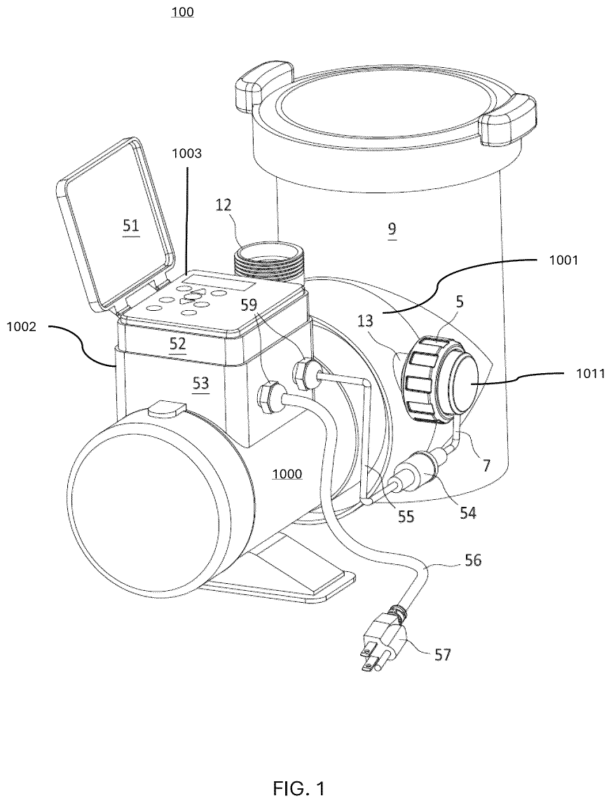

As shown in FIGS. 1-7, a fluid circulation system 100 having a pump 1001 for moving the fluid from a fluid outlet to a fluid inlet, a motor 1000 for driving the pump, and an ionizer 1011 for treating the water in the system is provided. The pump 1001 is preferably a dual port pump, for example the dual port pump described in U.S. Pat. No. 9,714,665, the contents of which are incorporated herein by reference. Preferably, a filter housing 9 containing a filter for filtration of the incoming fluid stream is also provided and connected to an inlet of the pump 1001. An embodiment of the present disclosure features a dual speed or variable speed motor 1000 couplable to the pump 1001 for turning it. The controller 1002 electrically coupled to the dual speed and/or variable speed motor 1000 determines the amount of electrical power delivered to the motor 1000 as well as the rotational speed of the motor 1000. An electrical load sensing circuit senses the electrical load on the motor 1000 for turning the pump 1001.

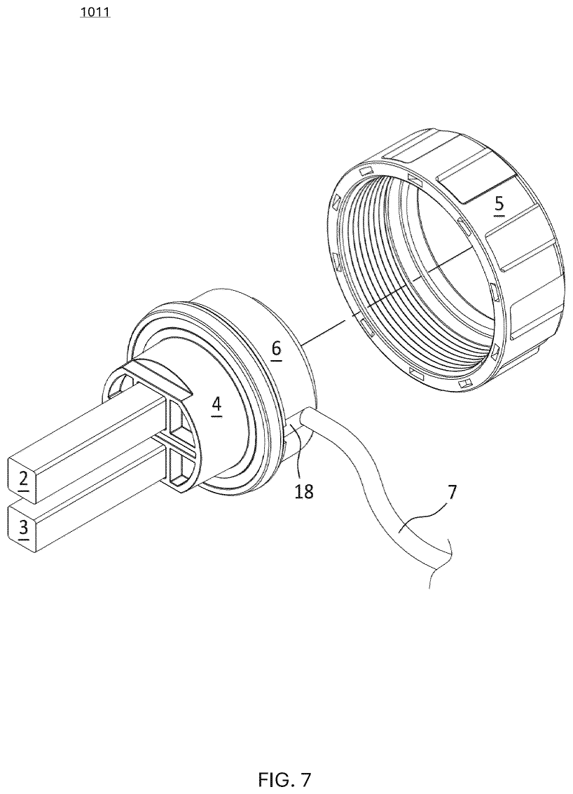

Referring to FIG. 7, the ionizer 1011 of U.S. Patent Application Publication No. 2024/0375979, the disclosure of which are incorporated herein by reference, may be used in conjunction with the present disclosure. The ionizer 1011 has a pair of electrodes 2, 3 for electrolytically ionizing flowing fluid in contact therewith, and which are mounted upon a head 4. Wires 7 extend into the head 4, e.g., through a notch 18 at a top end thereof opposite the electrodes, 2, 3, for connecting the electrodes to a system controller 1002 and a source of current for the ionizer 1011. The ionizer head 4 is dimensioned to securely seat on an outlet port 12 or 13 of the pump 1001, and is secured thereto, by a cap 6 and threaded nut 5.

The ionizer 1011 is especially suited for coupling onto a port 12/13 of a pool pump 1001 as disclosed, e.g., in U.S. Pat. No. 10,760,586, eliminating the need to directly mount the ionizer 1011 within the plumbing of the pool. The control mechanism can now be feasibly arranged remotely from the pump 1011, improving versatility. More particularly, as shown in the drawings, the pump 1011 has a motor housing 1000 mounted on one side of a fluid circulation system 100, with a strainer assembly 9 mounted on an opposite side of the fluid circulation system 100, and for use, e.g., above ground.

The controller 1002 generates outputs to activate and control the operational states of the motor 1000, and simultaneously an ionizer 1011 in a port 12, 13 of the pump 1001, and further defines an intended operational state for motor 1000 driving the pump 1001. The ionizer 1011 is secured into a port 12/13 by threaded nut 5. The controller 1002 can check a signal from a sensor to verify that an actual operational state of the pump 1001 is consistent with the intended pump 1001 state and terminates pump 1001 operation when an inconsistency exists.

In accordance with an embodiment of the present disclosure, the controller 1002 has a scheduling program for scheduling times for powering the motor 1000 to achieve different speeds, each speed having a corresponding criteria range of suction conduit vacuum values associated therewith, as well as providing power to the ionizer 1011 upon powering of the motor 1000.

The controller 1002 may also be used to control the times when the pump 1001 is operated pursuant to a schedule, as well as when the motor 1000 driving the pump 1001 is operated at different speeds. On start-up, the pump 1001 in some pool/spa installations, pond, or any other usage require time to establish a prime, viz., the filling of the suction conduit, strainer and fluid circulation system 100 with water. This is normally accomplished by running the pump 1001 at high speed. The motor 1000 speed required to prime the pump 1001 is more than that which is required to maintain effective filtration/circulation once prime has been established. Some states have recently passed laws that require pools and spas to have pumps 1001 that are operated at least two speeds, namely, at high speed to perform certain functions, such as priming and cleaning, and low speed to conduct filtration at a reduced usage of electrical power. After the acquisition of the prime, and if applicable, the setting of the pump 1001 speed to low speed for filtering operation, the pump 1001 speed is normalized. The controller 1002 may also have a display 1100 and input keys 1101 for an operator interface 1003, allowing the operator to read messages presented on the display 1100 by the controller 1002 and to provide input, such as selecting menu choices, answers and/or values by pressing selected keys.

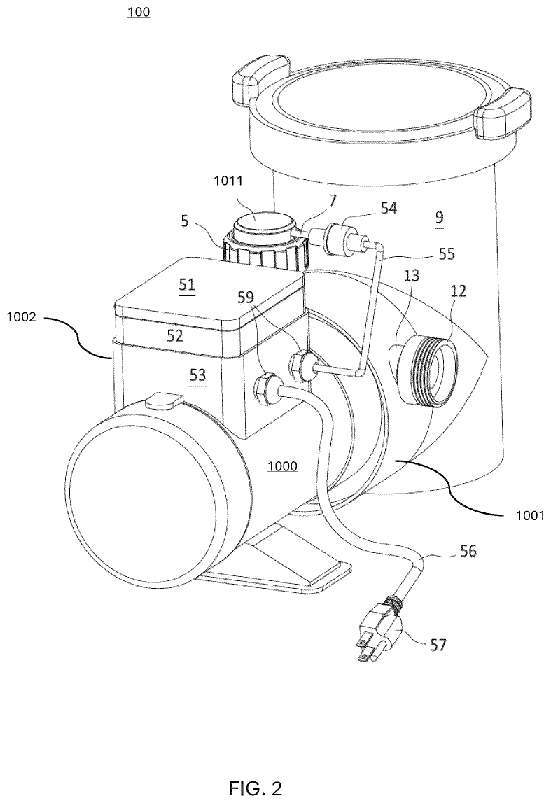

As shown in FIG. 1, the filter circulation system 100 can be provided with a controller 1002 coupled to the ionizer 1011 in turn coupled to outlet port 13 of the pump 1001, while FIG. 2 shows the ionizer 1011 coupled to outlet port 12. It is preferred that the motor 1000 be a dual speed motor or variable speed motor allowing for the motor 1000 to rotate at different speeds. The controller 1002 comprises a casing 52 on which a control panel/user interface 1003 is situated and closed by a hinged lid 51 (as shown in FIG. 2), with the casing 52 slid into and secured to a receptacle 53 in turn mounted on the housing of the motor 1000. The wires 7 extending from the ionizer 1011 are coupled to the control casing 52 through a waterproof connector 54 in turn connected to wires 55 leading into the control casing 52 through a coupler 59. Wires 56 lead out from the control casing 52 through another coupler 59 and terminate in a three-pronged plug 57 for connecting to a power source (alternatively, a twist-lock plug can be used). This embodiment, while preferred, is merely exemplary and one skilled in the art may configure the pump 1001, ionizer 1011, and controller 1002 in any manner such that at least these three components are in electrical communication with one another. The pump 1001, ionizer 1011, and controller 1002 share a common power source.

The controller 1002 operates the pump 1001 run time, including off and on duration and intervals, in addition to controlling ionizer 1011 output, supplying power to the ionizer 1011, and amount of such power depending upon level of contaminants and unwanted particles entrained in the flowing medium. This eliminates the need for a flow switch, which is prone to failure. The controller can have a countdown timer (as described herein as the preferred embodiment) and/or a 24-hour clock as its method to keep track of a time for scheduling various events. The 24-hour clock can be set by a user on start-up of the system.

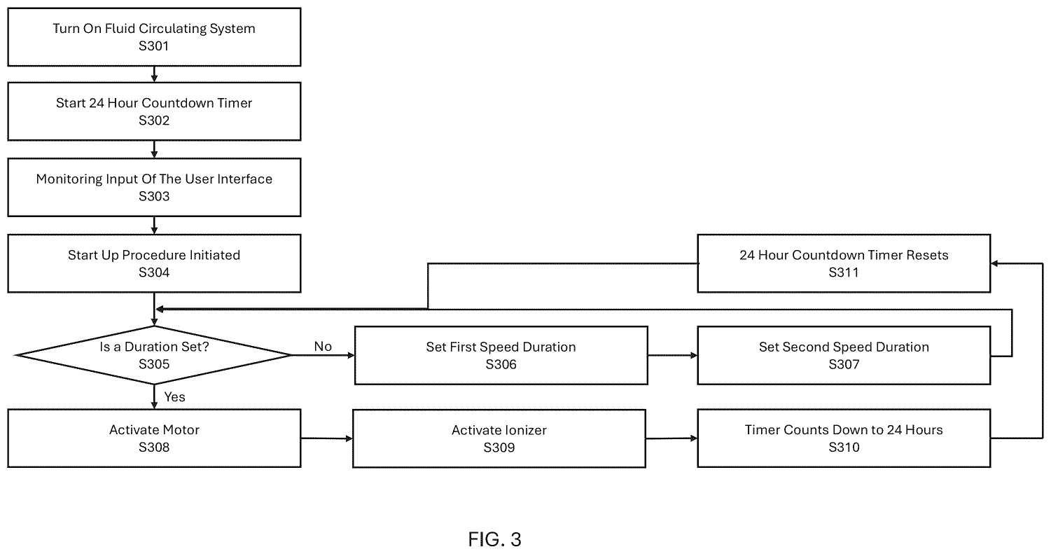

FIG. 3 shows a flow diagram for a controller operating a dual speed pump according to an embodiment of the present application. The pumping system is turned on at S301. Once the controller 1002 receives power, the controller 1002 begins a 24-hour countdown timer at S302. While a 24-hour timer is preferred, different durations, such as a 12-hour timer may be used. Also, the use of the 24-hour clock can also be used. The controller 1002 then monitors for an input on the user interface 1003 at S303, which may be initiated by a physical button, such as “START” or “RUN”, for example, located on the user interface 1003. The controller 1002 will then initiate a start up procedure at S304. In S305, the controller 1002 queries whether a duration has been set for a first and second speeds of a dual speed motor. If no, a user is directed to input a time value in S306 and S307. In a preferred embodiment, the first speed of S306 would be a high speed and the second speed of S307 would be a low or normal operation speed. In this embodiment, a user would be unable to change the speed of the first and second speeds although an embodiment where a user can change the speed, much like the variable speed pump described infra, is contemplated. Duration in S306 and S307 can be set in increments, such as, 15 minutes, 30 minutes, or 1 hour, although other increments are contemplated. The duration can be any time value from 0 hours to an increment below 24 hours for each duration and the combination of the duration of S306 and S307 cannot be a time value greater than 24 hours. It is contemplated that the duration need not be consecutive nor does the first speed need to begin at 0 hours. For example, the first speed can begin at 2 hours and run for 4 hours, and the second speed can begin 2 hours after the first speed has expired and run for 6 hours. In a system having a 12-hour countdown timer, the time value would range from 0 hours to 12 hours and the total time value could not be more than 12 hours. Once duration has been set in S306 and S307, the controller 1002 then returns to the query regarding whether a duration is set of S305, where the answer would be yes, and the motor 1000 would be activated in S308 and would run the first speed for the entered duration and the second speed for the entered duration. Upon activation of the motor 1000 in S308, the controller 1002 will supply power to activate the ionizer 1011 in S309. The controller 1002 controls the ionizer 1011 such that the ionizer 1011 will only activate if the motor 1000 is activated and, similarly, the controller 1002 controls the ionizer 1011 such that the ionizer 1011 will deactivate when the motor 1000 is deactivated. The effectiveness and longevity of the ionizer 1011 is increased by activating only when motor 1000 is activated and thus fluid is moving through the fluid circulating system. Further, by having the motor 1000 and ionizer 1011 work in tandem, this reduces the need to power and control two systems separately. In S310, the timer counts down to 24 hours and, upon the 24-hour countdown timer resetting is S311, the system returns to S305 and repeats until the controller 1002 is no longer receiving power. It is contemplated that the process described above may also be terminated by a physical button on the user interface 1003, such as “END” or “STOP”.

In an embodiment, on start-up, the pump 1001 requires time to establish a prime. This is normally accomplished by running the pump 1001 at high speed. The pump 1001 speed (and associated power consumption that is required to prime the pump 1001) is more than that which is required to maintain effective filtration/circulation once prime has been established. After achieving the prime conditions, the pump 1001 speed will be normalized. In one embodiment, a prime can be established at S304 as part of the start-up procedure. In another embodiment, a prime can be established and be a part of S306, such that any set duration would include approximately 15 minutes of priming. In yet another embodiment, S306 may entirely be dedicated to establishing a prime, and a user would be able to manually set the duration of priming. Ideally prime would last roughly 15 minutes, but the time in which the pump 1001 runs in order to establish a prime may be more than or less than 15 minutes given the size of the pool. This prime time value would be subtracted from the total countdown time.

It is contemplated that the fluid circulation system 100 can operate without user intervention. In an embodiment, a default mode of operation is pre-programmed prior to any user invention. In this embodiment, the user interface 1003 at S303 may present the user with an option to operate the fluid circulation system 100 in a default or custom mode of operation, where the default mode would be pre-programmed, and the custom mode would require setting the first speed duration of S306 and second speed duration of S307. Alternatively, the fluid circulation system 100 may immediately begin in a default mode of operation without user intervention and require user intervention in order to run a custom mode, in which the custom mode may, for example, interrupt or begin after the 24-hour countdown timer resets for the default mode. An example of a default mode of operation would allow for the pumping system to turn on at S301, controller 1002 beginning a countdown timer upon receiving power at S302, monitoring input of the user interface at S303, initiating start up procedure at S304, returning an answer of yes to the query regarding whether the first and second speed durations are set, and thus activating the motor 1000 at S308 and simultaneously activating the ionizer at S309. Priming, discussed supra, can also similarly be established during start up procedure S304, or be established as part of the duration of the first speed.

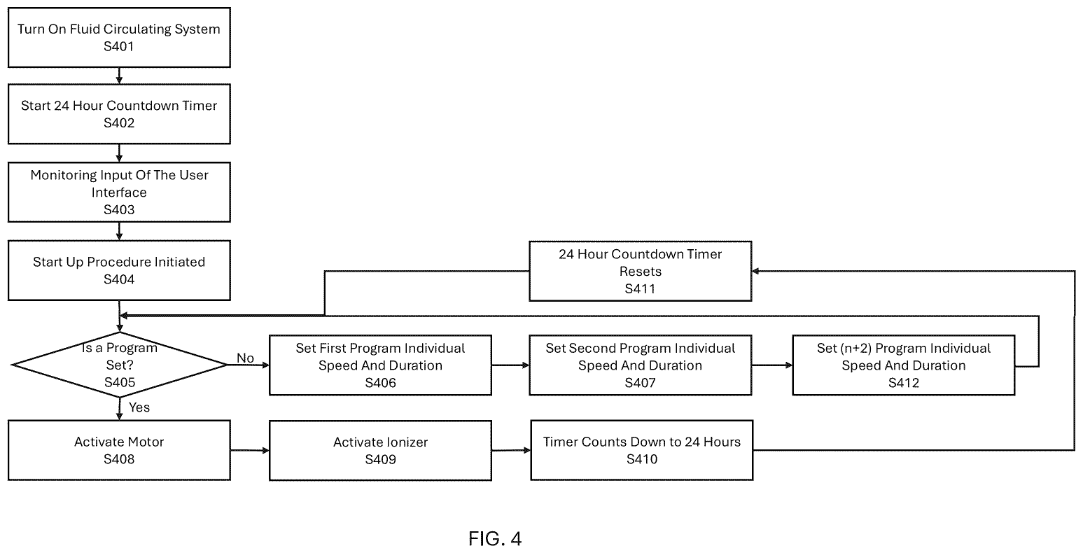

FIG. 4 shows a flow diagram for a controller 1002 operating a variable speed pump according to an embodiment of the present application. The pumping system is turned on at S401. Once the controller 1002 receives power, the controller 1002 begins a 24-hour countdown timer at S402. While a 24-hour timer is preferred, different durations, such as a 12-hour timer may be used. The controller 1002 monitors for an input on the user interface 1003 at S403, which may be initiated by a physical button, such as “START” or “RUN”, for example, located on the user interface 1003. The controller 1002 will then initiate start up procedure at S404. In S405, the controller 1002 queries whether a program has been set for various speeds of a variable speed pump. If no, a user is directed to input a time value and/or speed value in S406 and S407. Additional programs as seen in S412 may be added where “n” can represent any number. It is contemplated that n can equal zero resulting in only two programs capable of individualized programming of duration and speed. Preferably, “n” is equal to 1 for a total of 3 preset programs, but more than 3 settings are contemplated. Duration in S406 and S407 can be set increments, such as, 15 minutes, 30 minutes, or 1 hour, although other increments are contemplated. The duration can be any time value from 0 hours to an increment below 24 hours for each duration and the combination of the duration of S406 and S407, and possibly S412, cannot be a time value greater than 24 hours. It is contemplated that the duration need not be consecutive nor does the first speed need to begin at 0 hours. For example, the first program can begin at 2 hours and run for 4 hours, and second program can begin 2 hours after first duration has expired and run for 6 hours. In a system having a 12-hour countdown timer, the time value would range from 0 hours to 12 hours and the total time value could not be more than 12 hours. The system can utilize the 24 hour clock as described above. Similarly, speed may also be set in predetermined increments of, for example, revolutions per minute (RPM) or units of power, such as watts. Once a program has been set in S406, S407, and, optionally, S412; the controller 1002 then returns to the query regarding whether a duration is set of S405, where the answer would be yes, and the motor 1000 would be activated in S408 and would run the first speed for the entered duration and the second speed for the entered duration. Upon activation of the motor 1000 in S408, the controller 1002 will supply power to activate the ionizer 1011 in S409. The ionizer 1011 will only activate if the motor 1000 is activated and, similarly, the ionizer 1011 will deactivate once the motor 1000 is deactivated. The effectiveness and longevity of the ionizer 1011 is increased by activating only when motor 1000, and thus fluid, is moving through the pool system. Further, by having the motor 1000 and ionizer 1011 work in tandem, this reduces the need to power and control two systems separately. In S410, the timer counts down to 24 hours and, upon the 24-hour countdown timer resetting is S411, the system returns to S405 and repeats until the controller 1002 is no longer receiving power. It is contemplated that the process described above may also be terminated by a physical button on the user interface 1003, such as “END” or “STOP”. Similar to the dual speed pump embodiment, priming can be achieved by employing the same methods above and are subject to the same time constraints. Further, a default mode of operation may also be employed using the same methods above, in which a first program, second program and possibly an (n+2) program of S406, S407, and S412, respectively, would be pre-programmed with a speed and duration value and would be able to operate without user intervention.

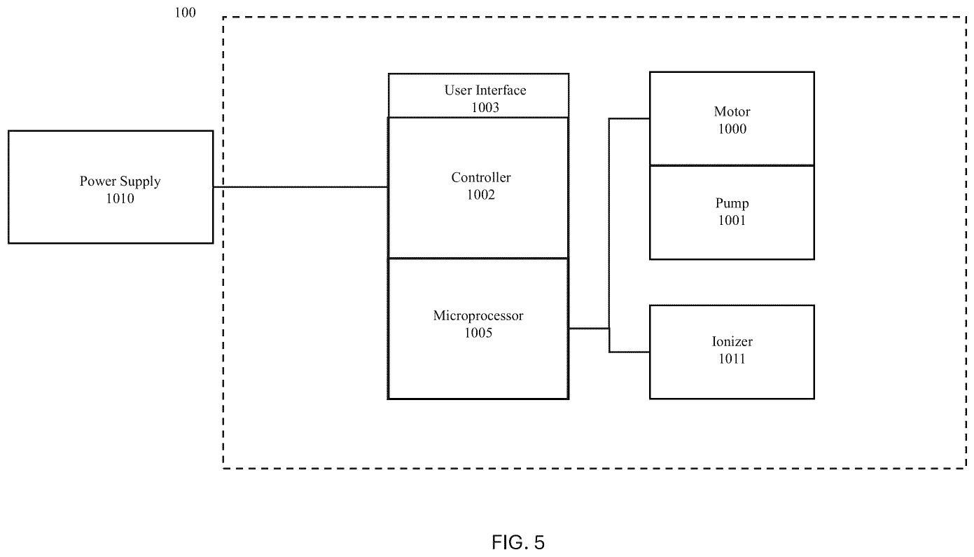

FIG. 5 shows a pump 1001 in communication with a motor 1000 and an ionizer 1011 with an electronic control module 1002 (pump controller) having a user interface 1003 and microprocessor 1005. The control module 1002 is mounted on the fluid circulation system 100. The motor 1000 drives an impeller (not shown) contained within the pump 1001 of the fluid circulation system 100. The microprocessor 1005 is used to control the speed of the pump motor 1000 which in turn would simultaneously activate the ionizer 1011 in the port 12, 13. The speed of the pump 1001, as previously described, may be preset or variable and thus speed and duration may be determined by instructions received from a user interface 1003. The user interface 1003 may be utilized to program a schedule of run times and speeds that can be stored in a memory (not shown) and executed by the microprocessor 1005. The pump motor 1000 may experience variations in loading and corresponding power draw depending upon changing conditions, e.g., during priming, filtering, changes in back-pressure attributable to clogging of the filter or occlusion of drain or skimmer lines.

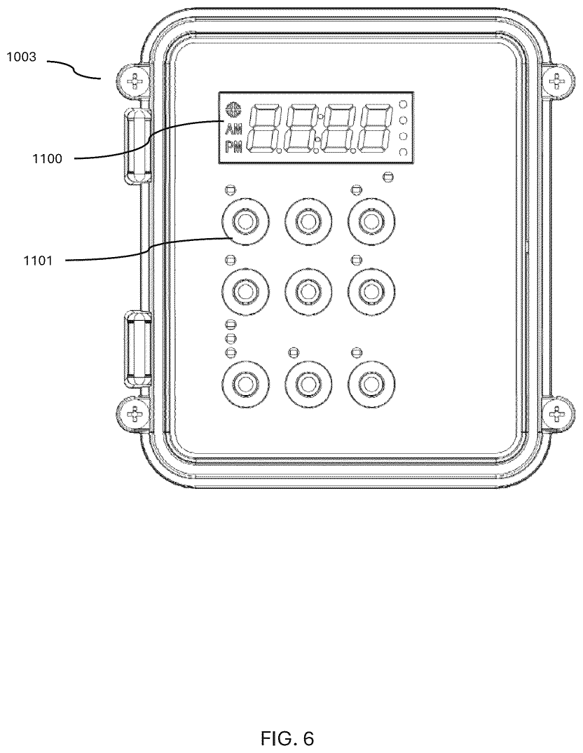

FIG. 6 shows an embodiment of the user interface 1003. The user interface 1003 is preferably housed in a waterproof enclosure and consists of push buttons (input keys) 1101. In an embodiment, it is contemplated that a set of at least two buttons 1101 would be dedicated to selection of the two speed options available on the dual speed pump. Additional buttons dedicated to specific programs are contemplated when used in combination with a variable speed pump. If a 24 hour clock is include, the user can set a current time via the user interface 1003. Navigation and input of the menus within the controller 1002 can be achieved with a combination of short press, long press, and sequential pressing of the buttons 1101. It is also contemplated that an additional group of buttons 1101 may be directed to navigation of the menus. It is further contemplated that other buttons 1101 can be programmed for a variety of purposes, such as increasing and decreasing incrementally, starting, stop, selecting, operating in a default or custom mode of operation, and navigation of menus. A display 1100 may also be included to allow the operator to read messages presented on the display 1100 by the controller 1002.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

Where this application has listed the steps of a method or procedure in a specific order, it may be possible, or even expedient in certain circumstances, to change the order in which some steps are performed, and it is intended that the particular steps of the method or procedure claim set forth herein below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A system for controlling a fluid circulation system, comprising:
a pump for circulating water, the pump having at least two outlet ports;
a motor connected to the pump to drive the pump;
an ionizer positioned in one of the outlet ports of the pump; and
a controller connected to the motor and ionizer;
wherein the controller is configured to provide power from a power supply to the motor to control activation of the motor and simultaneously provide power to the ionizer upon activation of the motor, and
wherein the controller is configured to terminate power to the motor and simultaneously terminates power to the ionizer.

2. The system of claim 1, wherein the controller further comprises a user interface.

3. The user interface of claim 2, further comprising push buttons.

4. The user interface of claim 2, further comprising a display.

5. A method for controlling a fluid circulation system having a motor driving a pump capable of dual speed operation and an ionizer, comprising the steps of:
providing power to a controller in electrical communication with a motor driving a pump and an ionizer;
initiating a timer upon receiving power to the controller;
initiating a start-up procedure of the controller;
setting a first duration for operating the motor;
setting a second duration for operating the motor;
activating the motor; and
upon activating the motor, activating the ionizer,
wherein the sum of the first speed duration and second speed duration is less than or equal to the total duration of the countdown timer.

6. The method of claim 5, wherein the countdown timer lasts 24 hours.

7. The method of claim 5, wherein the countdown timer lasts 12 hours.

8. The method of claim 5, wherein a prime is established during the start-up procedure of the controller.

9. The method of claim 5, wherein a prime is established during operation of the first speed.

10. A method for controlling a fluid circulation system having a motor driving a pump capable of variable speed operation, and an ionizer, comprising the steps of:
providing power to the controller in electrical communication with the motor and ionizer, and having at least two programs capable of individualized speed and duration;
initiating a timer upon receiving power to the controller;
initiating a start-up procedure of the controller;
setting a first speed and first duration for operating the motor;
setting a second speed and second duration for operating the motor; and
activating the motor and ionizer;
wherein the sum of the first duration and second duration is less than or equal to the total duration of the countdown timer.

11. The method of claim 10, wherein the countdown timer lasts 24 hours.

12. The method of claim 10, wherein the countdown timer lasts 12 hours.

13. The method of claim 10, wherein a prime is established during the start-up procedure of the controller.

14. The method of claim 10, wherein a prime is established during operation of the first speed.

15. The method of claim 10, wherein an additional speed and additional duration for operating the motor may be set.
